(19) United States
(12) Patent Application Publication
(10) Pub. No.: US 2008/0156205 A1
(43) Pub. Date: Jul. 3, 2008

(54) Method for transporting bent, irregularly shaped pieces of scrap sheet metal

(75) Inventor: Alfred George Hering, Plymouth, MI (US)

Correspondence Address: Bernard J. Cantor, 5685 Forman Drive, Bloomfield Hills, MI, 48301-1154, US

(73) Assignee: Soave Enterprises LLC

(21) Appl. No.: 11/648,823

(22) Filed: Jan. 3, 2007

(51) Int. Cl. B30B 5/00

(52) U.S. Cl. 100/245

(57) ABSTRACT

A method for transporting large quantities of convoluted, multiply bent, irregularly shaped, pieces of scrap metal from the location where they are produced to a remote location where the metal may be recycled, comprises flattening and temporarily binding together a batch of such pieces into an assembled wafer. The binding is produced by applying a compressive force of sufficient intensity to temporarily interconnect the pieces together but of insufficient intensity to interconnect the piece tightly enough to resist disassembly of the wafer upon impacting the assembled wafer. After the formation of a wafer comprising the interconnected numerous pieces, the wafer is transported to a remote site for recycling the metal. At such remote site, the wafer is disassembled into its constituent pieces by applying an impact to the wafer of sufficient intensity to cause the disengagement of the pieces for disassembling the wafer. The impact may be applied by dropping the wafers from a predetermined height above a ground surface for gravity falling and striking against the surface. The force of the impact may be assisted by vibrating the wafer when it is raised above the surface.

### BACKGROUND OF THE INVENTION

This invention relates to a method for transporting large quantities of bent, irregularly shaped, pieces of scrap sheet metal from a site where the scrap is generated in a manufacturing process to a remote site where the pieces may be processed for recycling the metal.

Industrial processes which utilize sheet metal to form useful parts by stamping or punching or drawing sheet metal generate large quantities of scrap metal pieces. These scrap pieces, which may constitute trimmings or other unused portions of initially flat sheet, are typically bent or convoluted and irregular in shape or size. It is common to collect and transport such loose, scrap metal pieces, for transporting them to a site where the metal pieces may be recycled, such as by melting them in a conventional electrical melt furnace.

Transporting loose, multiply bent or convoluted pieces is a problem because each piece occupies a considerable volume of space. Therefore, the amount of such pieces that can be transported at any one time in a single transportation container is limited. In order to reduce the volume occupied by each piece, and to reduce the cost for transporting a large number of such scrap metal pieces, it has been common to compact a number of these into bales or blocks. That permits transporting, in a single container, a far greater quantity of scrap pieces than otherwise could be transported if the pieces were loose. In addition, handling, loading and unloading unitary bales of the scrap is more efficient than with loose pieces.

The containers that are commonly used for transporting such scrap are in the form of large metal boxes, frequently with open tops, or cargo carrying portions of dump trucks or trailers or in railroad cars. These containers are commonly of a sufficient size, shape and strength to hold and transport substantial weights. Consequently, a number of bales or blocks, comprised of compacted together scrap pieces, can be efficiently carried within the containers for transportation to remote sites where the metal is recycled.

Recycling such scrap metal typically involves dropping the scrap metal into a melt furnace where the heat of the furnace liquefies the metal. The liquid metal is then solidified into ingots or other conventional forms for producing new sheets therefrom.

A large block or bale of metal requires a substantial amount of heat and substantial amount of time for the heat to penetrate throughout the block for melting the block in a furnace. Separated metal pieces melt much faster. Thus, it is desirable to melt separated individual pieces of scrap in the furnace. This conflicts with the desire to form the separate metal pieces into a compact, unitary bale or block for transporting them. Thus, it is an object of the present invention to provide a method for compacting a large number of separated scrap pieces together into a compacted wafer, similar to a relatively thin bale, and then disassembling the wafer when its constituent pieces are to be melted. The wafers may be efficiently transported. And later melting the separated metal individual pieces requires much less heat and time for melting the metal than would be required for melting the wafer.

The present process aims toward reducing the volume required, for transporting large numbers of otherwise bulky, hard-to-manage, convoluted, irregularly shaped and size pieces of sheet metal by compacting them into a unitary wafer formation and then transporting numerous wafers to, and disassembling the wafers at, the site where the metal is to be processed for recycling. That reduces the space needed for transporting the pieces from the site where they are generated, by enabling each transportation container to carry many more pieces than if the pieces were separated. But, still separate pieces of metal are fed into a melt furnace for obtaining the reduced cost and time benefits resulting from melting separated pieces.

One example of a system for handling numerous large, bent, irregular pieces of sheet metal is disclosed in my U.S. Pat. No. 6,923,033-B2, issued Aug. 2, 2005 for a “Roller System for Flattening Irregularly Shaped, Bent Pieces of Scrap Sheet Metal.” In that patent, a roller system is provided for flattening large quantities of bent, scrap sheet metal by squeezing the pieces between a pair of aligned rollers. This results in a substantial reduction in the amount of space occupied by each piece which enables transporting more pieces in a container.

Another example of compacting loose, bent, scrap metal pieces into large blocks or bales, transporting them and then breaking the bales into their constituent pieces is disclosed in U.S. patent application Ser. No. 11/235,627, filed Sep. 26, 2005 by Donald R. Schomisch et al. for a “Apparatus and Method for Temporarily Compressing Loose, Multiply Bent, Pieces of Scrap Sheet Metal Into Compacted Wafers.” That application discloses a ram compression system for compacting large quantities of loose pieces of scrap, sheet metal into compacted layers and later disassembling the bales into their constituent layers and separate pieces forming layers, for melting the sheet. The method disclosed in this present application predates the invention disclosed in such above-mentioned application and can utilize various methods which flatten or otherwise reduce the bends in scrap metal pieces and compacting the pieces into relatively thin wafers which are easily disassembled into their constituent pieces.

### SUMMARY OF INVENTION

The method herein contemplates transporting large quantities of irregularly shaped, bent or sized thin, scrap, sheet metal pieces that are generated in various conventional, industrial manufacturing processes. The method involves forming a batch of loose pieces and flattening and compacting the pieces together into relatively thin wafers by a force that is sufficient to bind adjacent pieces together temporarily. The force is insufficient to withstand a secondary impact or force that is later applied to the assembled wafer, after the wafer is transported. Thus, wafers, one by one, may be formed and then transported from the site where the scrap is generated to a remote site where the metal is to be processed for recycling. At that site, the wafers are disassembled by applying the secondary force to each wafer. The secondary force may be applied to dropping the wafers from a predetermined height upon a firm support, such as the ground, so that the constituent pieces of the wafer separate for melting purposes. Thus, the benefits of reducing the volume of space occupied by the scrap metal pieces for transportation purposes and the benefits of melting separate pieces are both provided. Consequently, the expenses, time, and equipment needed for transporting large volumes of scrap material and for recycling the scrap material are reduced and the processing is simplified.

A significant object of the present invention is to enable the efficient removal of large quantities of bulky scrap sheet metal pieces from a factory which processes sheet metal into various industrial products and to provide a relatively inexpensive system for transporting the scrap sheet metal pieces to a remote site where the scrap pieces may be recycled by melting the material.

Another object of this invention is to utilize compacting equipment to provide a force to produce relatively thin, temporary, compacted wafers formed of a batch of bent and irregularly shaped and sized pieces of scrap sheet metal, for transporting the wafers in suitable containers or vehicles to a remote site where the wafers may be easily disassembled by applying a secondary force to each of waver, such as by lifting it above a ground surface and gravity dropping it or by otherwise impacting the wafer. Vibration force may also be applied to the wafers to assist in separating the pieces.

Still another object of this present invention is to provide a method for substantially reducing the volume of space needed for transporting large numbers of irregularly shaped, sized and bent pieces of scrap sheet metal, for reducing the amount of transportation equipment needed for moving the scrap to a remote site for recycling the metal, while still providing the pieces in their separate condition for melting the metal.

A further object of this invention is to increase the value of large quantities of scrap sheet metal pieces by providing a method for economically delivering individual pieces to metal recycling melt furnaces while economically transporting the pieces from the site at which they were generated to the recycling site.

These and other objects and advantages will become apparent upon reading the following description, of which the attached drawings form a part.

### DESCRIPTION OF DRAWINGS

The drawings described herein are for illustration purposes only and are not intended to limit the scope of the present disclosure in any way.

FIG. 1 is a schematic illustration of a compacting system for receiving and compacting a batch of irregularly shaped and sized bent pieces of sheet metal, preferably with a single thrust of a ram against a backing platen.

FIG. 2 is a schematic illustration showing the ram, moved towards the platen for squeezing, compacting and binding together the batch of previously loose pieces of sheet metal to form a relatively temporary, unitary wafer.

FIG. 3 is a schematic illustration showing the movement of the platen out of the way and the ram pushing the wafer out of the compacting equipment towards a container for receiving the wafer for transporting purposes.

FIG. 4 is a schematic illustration of an individual wafer being lifted above the container and then dropped upon a ground or other firm surface for applying a secondary force resulting from the impact to disassemble the wafer into its constituent pieces.

FIG. 5 schematically illustrates a modification in which the wafer is removed from the transportation container and is dropped, as it disassembles, into the liquid, molten metal puddle in a melt furnace.

FIG. 6 schematically illustrates a sample irregularly shaped and sized, multiply bent piece of thin sheet metal.

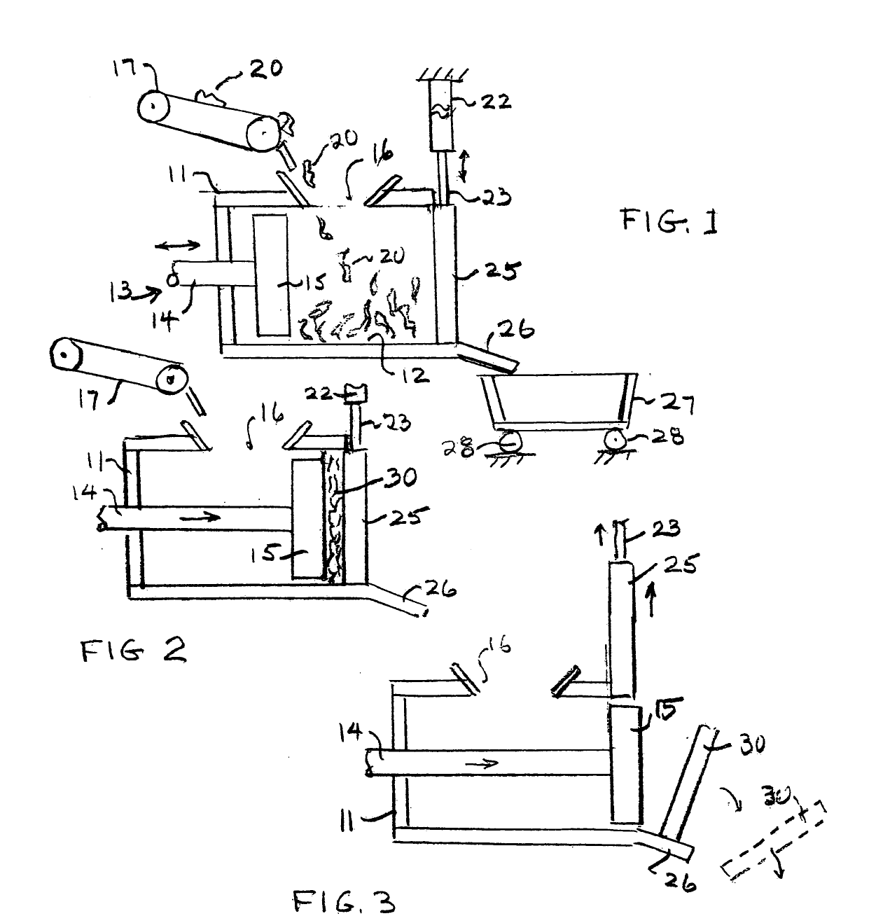

### DETAILED DESCRIPTION

The attached drawings schematically illustrate a compacter 10 which comprises a housing 11 within which a compression chamber 12 is provided. A reciprocating ram 13, preferably powered by a suitable hydraulic system, not shown, includes a drive shaft 14 upon which a ram pressure head 15 is mounted. The ram reciprocates within the housing and through the compression chamber as will be described below.

The housing has an entrance hopper 16 located beneath the exit portion of a feed conveyor 17. The conveyor 17 may consist of a number of conveyors, arranged end to end, which carry scrap metal pieces from within a factory building containing manufacturing equipment, such as stamping presses, punch presses, shears, etc. which, in one way or another, operates upon sheet material and in so doing produces scrap in the form of trimmings, punched out portions, etc. Pieces of scrap designated by the numeral 20 (see FIG. 6), resulting from the industrial process within the factory, are conveyed along the conveyor and either directly, or through suitable ramps or chutes (not shown), cause the pieces of scrap sheet metal to drop downwardly into the compression chamber 12 through the entrance hopper 16 in the housing. A number of pieces of scrap sheet metal accumulate within the compression chamber while the ram pressure head 15 is retracted as schematically illustrated in FIG. 1. That forms a batch of loose pieces of scrap sheet metal within the compression chamber.

Opposite the ram head, a lift cylinder 22, which may be hydraulically operated with suitable controls, moves a vertically reciprocating piston rod 23 which is attached to a platen or anvil 25. The platen or anvil initially closes off the exit end of the housing. Thus, it functions as a backing or anvil against which the sheet metal pieces are pressed by the ram.

Preferably, a predetermined number of loose pieces are collected within the compression chamber. The number of pieces may be calculated by counting the number of pieces by means of an automatic conventional counting device or by determining the weight of the collected pieces or by the passage of a pre-determined amount of time known by experience to accumulate enough scrap pieces to make a batch. The ram is operated for compressing the pieces of scrap metal together and against the platen. The force of the ram, which preferably is operated with a single, power stroke, compresses the pieces in the batch against each other and against the platen. That force tends to substantially straighten much of the bends and convolutions of the pieces and to simultaneously cause adjacent portions of adjacent pieces to inter-engage or embed within one another to temporarily hold all of the pieces of sheet metal together. The amount of force applied by the ram is pre-determined to provide sufficient force to cause the pieces to bind together. But, the amount of force is below the amount which would permanently or substantially permanently hold the pieces together, yet at the same time is sufficient enough to prevent the loose pieces from falling apart until a further, secondary force is applied.

By way of example, with a load of approximately 1,000 pieces of a total weight of 1,200 pounds, a ram pressure of roughly 200 to 250 pounds per square inch will force the pieces together into a relatively thin, temporary wafer of approximately 40 to 50 inches in height and width and 8 inches in thickness. These figures are given as illustrative; the sizes may vary in the operation of the equipment. The determination of the pressure to utilize for a particular size batch or load generally will be determined by empirical testing. The object is to cause the previously loose pieces to stay together, bound into the unitary wafers, until such time as a sufficient secondary force is applied to the wafers causing them to disassemble into the separate pieces. That amount of pressure would vary depending upon the particular thickness, size, convolutions and material which make up each of the separate pieces of scrap. Typically, in a high production factory operation, the batch sizes would be consistent and thus be determined empirically by experience.

After the ram has operated to compress the pieces together against the platen or anvil 25, the platen may be lifted upwardly, in the equipment illustrated, to open the exit end of the housing. A suitable discharge ramp or discharge slide or support 26 or conveyor (not shown) is arranged at the opening of the housing. A container 27 is arranged at the end of, or adjacent, the discharge ramp for receiving the wafers. By way of example, the illustrated container 27 is provided with wheels 28 so that it would be similar to a trailer which, when connected to a truck-type tractor, can be removed and replaced periodically when it is filled.

Initially, the ram force for forming the wafers 30 into suitably compressed stable, solid units may be determined by trial testing to obtain the best compression pressures for the particular type pieces. Then, after determining the necessary pressure, the newly formed wafers are produced. One by one, the wafers are formed and pushed out of the opening in the housing by lifting the platen. The ram moves the wafers until the wafer moves upon the discharge ramp 26. Thereafter, the wafer is moved until it is deposited into the container 27.

When enough wafers have been dropped into the container to provide a full load, which can be determined by weight of the container when it is filled or by the number of wafers in the container, or by the amount of lapsed time of operation which correlates to the number of wafers, the filled container is removed and replaced with an empty one.

The filled container may then be moved to a recycling processing site 32 which is typically remote from the location where the scrap is generated.

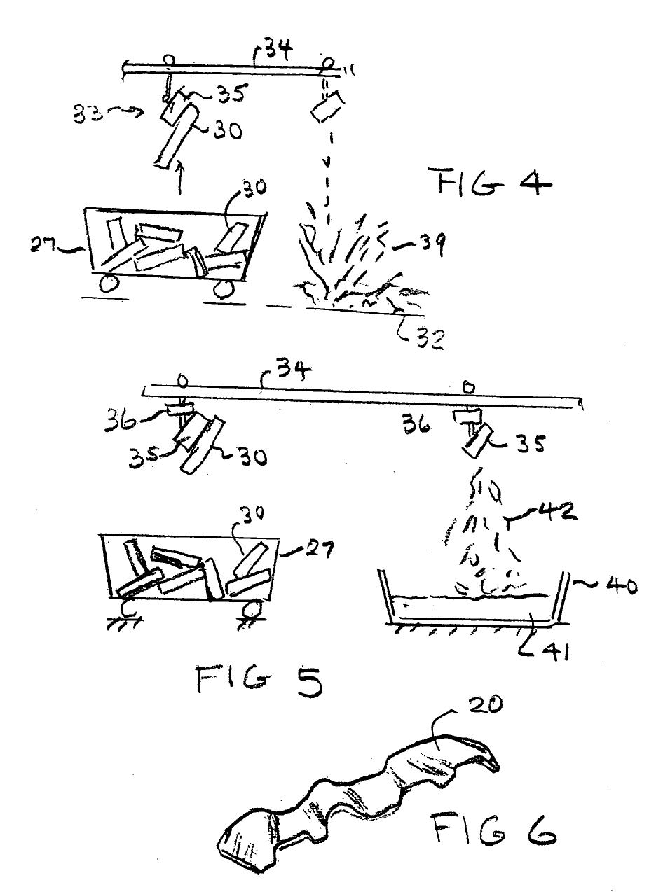

At the recycling processing site, which can be a storage yard for scrap or a melt furnace or equipment for either storing or immediately processing the scrap, a crane 33 is arranged to lift the scrap wafers from the container. By way of example, almost any conventional crane would be suitable if it has sufficient capacity and strength. The schematic illustration in FIG. 4 of a crane shows an overhead rail 34 beneath which a conventional magnetic lifting device 35 is provided. Where the sheet metal is of a ferrous material, the magnetic device 35 lifts each wafer out of the container. The wafer may be moved laterally of the container and dropped upon a firm surface to provide an impact force which disassembles the wafer (see FIG. 4). Alternatively, the wafers may be deposited upon a pile for storage and later lifted and dropped or subjected to another force to cause its pieces to separate. Similarly, the wafer may be deposited into a melt furnace where the impact with the melt in the furnace provides the force.

Other suitable cranes or lifting devices may be used, particularly if the scrap metal is of a non-ferrous material.

To assist in the disassembly of the wafer, commercially available vibrator equipment 36 may be mounted on the crane or the lift device for vibrating the wafer and providing a vibrational force to the wafers. Preferably, the wafer is lifted high enough above the ground surface 37 so that the force of the impact with the ground surface is sufficient to disassemble the wafer. If a vibrating mechanism is added, the force of the vibration helps to disconnect the separate pieces constituting the wafer. The secondary forces of either or both the impact and vibration overcome the binding together of the individual pieces, as represented schematically by the lines 39 in FIG. 4.

FIG. 5 illustrates an alternative comprising depositing the separated pieces of the wafer directly into a melt furnace 40. FIG. 5 shows schematically, a conventional melt furnace containing a puddle of molten material 41. In that scenario, the wafer 30 is moved over the opening in the melt furnace and then dropped, with vibration, into the puddle of molten material 41. The rain of disassembled pieces caused by vibration, schematically indicated by numeral 42, would then be deposited directly within the furnace where each piece is individually subjected to the heat of the furnace and thereby melted.

Although a thicker, larger block or bale may be formed by repeated impacts of the ram against a large batch of pieces within the compression chamber of the equipment, it is preferable in this operation to accumulate in the compression chamber a predetermined amount of pieces and to compact those pieces with a single push against the platen for forming a single thin wafer. That single wafer can be relatively easily handled in maintaining the wafer structure and later in disassembling the pieces constituting the wafer.

The above batch-type system with an appropriate ram pressure can process a large number of tons per hour of scrap material. For example, in a stamping plant producing large numbers of sheet metal parts for automobile manufacturing use, the resulting scrap amount is very large. Hence, it is necessary to remove the scrap material rapidly and efficiently. Thus, as an example, a ram force of 200-250 pounds per square inch on the face of the ram, with a batch of approximately 1,200 pounds of scrap material in the compression chamber, essentially causes the bends or irregular portions of adjacent pieces to interlock. Also, the portions of the pieces around the periphery of the wafer tend to bend and curl or otherwise interlock with adjacent portions of other pieces so that there tends to be interlocking of the pieces around the peripheral edges of the wafer. This tends to hold the pieces together and to increase the structural integrity or unity of the wafer.

As mentioned, the particular pressures, batch sizes, and other processing parameters may vary depending upon the nature of the scrap material processed. Hence, trial experience with the equipment may be desirable to determine the optimum operating conditions. Once determined, those conditions can be used consistently for a particular scrap processing operation. Similarly, the conditions may be changed if, for example, a factory uses sheet metal of different types or thicknesses. In that case, at different times in the operation of the system the operating parameters need to be adjusted accordingly. Thus, optimum conditions may be determined by observation for each type of scrap material that is processed. Summarizing, the method contemplates formation of the scrap pieces by an initial force into temporary unitary wafers, which are transported and then disassembled into their separate pieces by application of a secondary force.

This invention may be further developed within the scope of the following claims. Accordingly, the foregoing description should be read as being merely descriptive of an operative, preferred embodiment of this invention and not in a strictly limiting sense. I now claim.

What is claimed is:

1. A method for transporting large numbers of irregularly shaped and sized, multiply bent, pieces of scrap sheet metal from a location where such scrap may be generated or located to a remote site from which the scrap may be processed for recycling the metal, comprising:
collecting a batch of such pieces and binding them together temporarily into a relatively thin wafer;
including forming the batch by accumulating a number of said pieces in a compression chamber;
applying a compressive force against the batch of such accumulated batch of pieces to press the pieces together against a support to substantially flatten the pieces and simultaneously cause adjacent pieces to temporarily interconnect together;
with the intensity of the force being selected to be sufficient to cause adjacent portions of adjacent pieces to inter-engage for temporarily binding such pieces together, but with such force being insufficient to hold the bonded pieces together when a later force is externally applied to the assembled wafer;
transporting the wafer to a disassembly location;
applying said later force against the wafer to cause the bonded-together pieces to disconnect and to thereby separate the wafer into its constituent pieces for subsequently processing the pieces for recycling the metal.

2. A method as defined in claim 1 and including bending and inter-engaging bent portions of the pieces located along the periphery of the wafer as the wafer pieces are forcibly compressed together so that the inter-engaged peripheral portions tend to temporarily secure the pieces together to form the wafer.

3. A method as defined in claim 1 and including lifting the assembled wafer above the ground a predetermined distance and dropping it by gravity upon the ground to provide an impact force resulting from the wafer striking the ground of sufficient intensity to cause the constituent pieces of the wafer to separate for disassembling the wafer.

4. A method as defined in claim 3, and feeding the separated pieces into a melt furnace for melting the pieces and thereby recycling the metal comprising the pieces.

5. A method as defined in claim 1 and including holding the wafer at a predetermined distance above a collection location and subjecting the wafer to a vibration force and a gravity force sufficient to substantially separate the pieces for disassembling the wafer.

6. A method as defined in claim 5 and holding the wafer above a collection location at a predetermined height to provide a substantial impact force by dropping the wafers against a surface, and dropping the wafer under the influence of gravity for causing them to separate, and placing the separated pieces into a melt furnace for melting the separated pieces.

7. A method for transporting large quantities of thin, contorted, multiply bent and irregularly shaped pieces of scrap sheet metal generated in a manufacturing procedure from the location of the procedure to a remote location for recycling the metal, comprising the steps of:
collecting a batch comprising a substantial number of individual, separate scrap metal pieces at a first location, such as near where the scrap pieces are produced in a manufacturing procedure;
applying a first force against the batch of pieces to compress the pieces together to form a unitary wafer;
with said first force being sufficient to cause adjacent portions of adjacent pieces to interconnect sufficiently to bind the pieces together in the wafer formation, but with said first force being insufficient to bind the pieces against separating when a second force of a different intensity is later applied to the wafer;
transporting the wafer, with other wafers formed in the same manner, to a remote location for processing the metal of the pieces for recycling the metal;
applying a second force externally to the wafer, with the second force being sufficient to cause the pieces to disengage from each other for disassembling the wafer into its constituent separate pieces.

8. A method as defined in claim 7, and including melting the separated pieces from the wafer for recycling the metal of the pieces.

9. A method as defined in claim 7 and including lifting the assembled wafer a predetermined distance above a surface and dropping it upon the surface by gravity for applying the second force resulting from the impact with said surface, and to provide sufficient intensity of said second force to cause the constituent pieces of the wafer to separate from each other for disassembling the wafer.

10. A method as described in claim 7 and including feeding the separated pieces from the wafer into a melt furnace for melting and thereby recycling the metal.

11. A method as defined in claim 7 and including applying vibrational forces to the wafer when it is lifted above the surface for tending to separate the constituent pieces forming the wafer.

12. A method as defined in claim 7 and including applying said second force by raising the wafer to a predetermined height above a surface and dropping the wafer upon the surface so that the impact of the wafer striking the surface provides the second force.

13. A method as defined in claim 12 and including vibrating the wafer when it is lifted above said surface.

14. A method as defined in claim 7 and including substantially flattening the pieces when they are subjected to said first force.

15. A method for improving the meltability and, therefore, the value of large quantities of individual pieces of scrap sheet metal that are provided to melt furnaces for recycling the metal, comprising:
collecting a batch of separate pieces of multiply bent, irregularly shaped pieces of scrap sheet metal generated at a manufacturing site at which sheet metal is processed into industrial parts;
applying a first force to the batch to substantially flatten and to compact, interlock, and bond the pieces together into a temporary compact unit formed of said pieces;
transporting the unit to a remote site for recycling the metal;
applying a second force to the unit at said remote site, with the force being sufficient to overcome the bonding of the pieces together for thereby separating the unit into its constituent pieces;
whereby the separated pieces may be fed into a melt furnace for individual exposure to the furnace heat for melting and recycling the metal.

16. A method as defined in claim 15, and wherein the second force is applied to the unit by raising the unit a predetermined distance above a firm surface and gravity-dropping it upon the surface so that the impact of the unit against the firm surface causes the pieces to separate for disassembling the unit into its constituent pieces.

17. A method as defined in claim 15, and including vibrating the unit to apply a force to the unit for separating the unit into its separate constituent pieces for feeding the individual pieces into the melt furnace.
